(19) United States
(12) Patent Application Publication
(10) Pub. No.: US 2006/0147133 A1
(43) Pub. Date: Jul. 6, 2006

(54) Fluid Dynamic Bearing, Spindle Motor, Recording Disk Driving Device, and Method of Manufacturing Fluid Dynamic Bearing

(75) Inventor: Masayoshi Saichi, Kyoto (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: NIDEC CORPORATION, Kyoto (JP)

(21) Appl. No.: 11/276,685

(22) Filed: Mar. 10, 2006

(30) Foreign Application Priority Data
Aug. 8, 2003 (JP) JP2003290806

(51) Int. Cl. F16C 32/06; B21K 1/10

(52) U.S. Cl. 384/100; 29/898.02

(57) ABSTRACT

A lubricant resin layer which is oil resistant is formed on an outer surface of a metallic core portion which is used as a base frame of a shaft. The lubricant resin layer is formed by radially injecting molted resin from a portion on the rotation axis within the metallic core portion into radially outward direction. As a result, the lubricant resin layer having substantially uniformed thickness is formed.

### BACKGROUND OF THE INVENTION

1. Technical Field

The present invention generally relates to a spindle motor, a recording disk driving device, and a fluid dynamic bearing which relatively rotatably supports a shaft and a sleeve by dynamic pressure of lubricant fluid. The present invention also relates to a method of producing the fluid dynamic bearing.

2. Background Art

Recently, people skilled in the art trying to develop a fluid dynamic bearing which is capable of securely supporting various kinds of rotors that rotate at high-speed. Generally the fluid dynamic bearing includes a gap filled with lubricant fluid such as oil and formed between an inner circumferential surface of a sleeve and an outer circumferential surface of a shaft which is relatively rotatably inserted into the sleeve 1. When the rotor rotates, the pumping force of the rotation generates dynamic pressure on the lubricant fluid which supports the rotor.

In the conventional fluid dynamic bearing, when the rotor starts or stops the rotation thereof, the rotation speed decreases and the dynamic pressure decreases as well. As a result, the shaft and the sleeve rotate with contacting each other, therefore, the shaft and the sleeve may wear out and the product life of the bearing may be shortened

### BRIEF SUMMARY OF THE INVENTION

A fluid dynamic bearing according to the present invention includes a sleeve having an inner circumferential surface, a shaft being relatively rotatable to the sleeve and having an outer circumferential surface facing the inner circumferential surface when being inserted into the sleeve, and a lubricant fluid retained between the inner circumferential surface of the sleeve and an outer circumferential surface of the shaft.

A method of manufacturing the fluid dynamic bearing according to the present invention includes a step of providing a metallic core portion which is a part of the shaft and has a injection molding path penetrating the metallic core portion along with a rotation axis, a step of providing a die, a step of arranging the metallic core portion, and a step of forming resin layer on an outer surface of the metallic core portion by injecting molten resin through the injection molding path.

One preferred embodiment according to the present invention provides a fluid dynamic bearing which has high stiffness, high accuracy, and excellent lubricity with maintaining a simple structure. In addition, the dynamic pressure of the lubricant fluid is maintained appropriately in the fluid dynamic bearing, such that the reliability of the fluid dynamic bearing, the spindle motor, and the recording disk driving device may be easily and dramatically improved.

Therefore, it is possible to provide a fluid dynamic bearing, a spindle motor, and a recording disk driving device, which are highly reliable and shock-resistant.

In the description of the present invention, words such as upper, lower, top, bottom, left, and right for explaining positional relationships between respective members and directions merely indicate positional relationships and directions in the drawings. Such words do not indicate positional relationships and directions of the members mounted in an actual device.

### BRIEF DESCRIPTION OF THE SEVERAL VIEWS OF THE DRAWINGS

FIG. 1 is a longitudinal sectional view showing the first preferred embodiment according to the present invention.

FIG. 2 is a longitudinal sectional view showing the second preferred embodiment accord to the present invention.

FIG. 3 is a longitudinal sectional view showing the recording disk driving device according to the present invention.

### DETAILED DESCRIPTION OF THE INVENTION

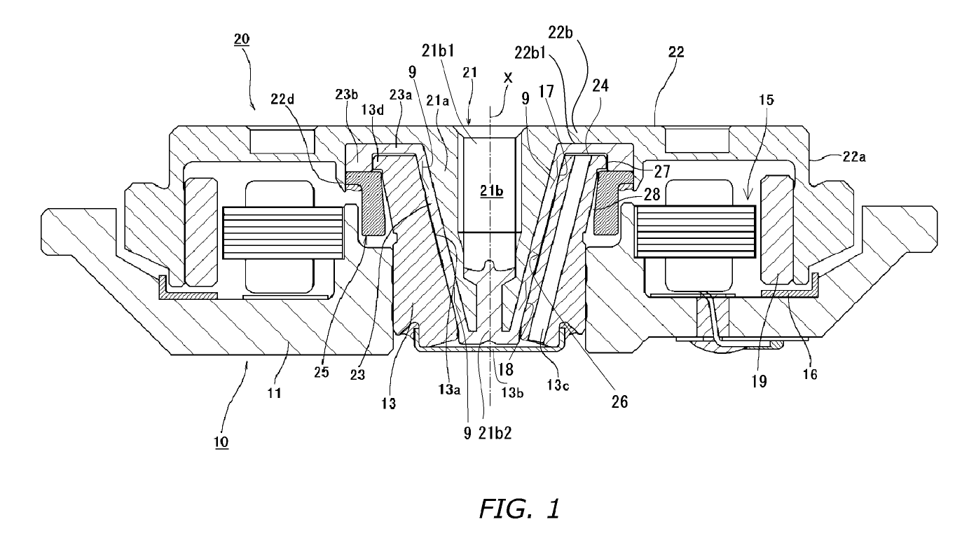

With referring to FIGS. 1 to 3, preferred embodiments according to the present invention will be described below.

### First Preferred Embodiment

A spindle motor shown in FIG. 1 includes a stationary assembly 10 and a rotor assembly 20. The rotor assembly 20 is attached to the stationary assembly from an upper side according to the FIG. 1.

The stationary assembly 10 includes a base frame 11. A sleeve 13 formed in a hollow shape is integrally connected to a substantially center portion of the base frame 11 by any suitable means such as press fitting and shrink fitting. The sleeve 13 is formed with copper family materials such as phosphor bronze to facilitate the manufacturing. In addition, the sleeve 13 includes a central hole 13a which penetrates the sleeve 13 in an axial direction and is in a substantially conical shape. A stator 15 is fixed to the substantially center portion of the base frame 11.

A shaft 21 whose outer circumferential surface is in a substantially conical shape is inserted into the central hole 13a of the sleeve 13 so as to rotate around the central axis X. At a substantially center portion of the inner circumferential surface of the sleeve 13, a toroidal recessed portion is formed as a zonal oil pan.

A bottom opening portion of the sleeve 13 is occluded with a cover 13b so that the oil maintained within a radial gap 26 does not leak.

A rotor hub 22 in a substantially cupped shape is integrally formed with an upper portion of the shaft 21. The rotor hub 22 includes a disk portion 22b and a cylinder portion 22a which downwardly extends from an outer circumferential portion of the rotor hub 22. A rotor magnet is fixed to an inner circumferential portion of the cylinder portion 22a. The rotor magnet 19 radially faces an outer circumferential surface of the stator 15 with a gap maintained therebetween.

A magnetic plate 16 is fixed to the base frame 11 and axially faces a bottom end surface of the rotor magnet 19 with a gap maintained therebetween. The rotor hub 22 is axially attracted by the magnetic attractive force between the magnetic plate 16 and the rotor magnet 19, such that the rotor hub 22 rotate in a stable manner.

A structure of a bearing will be described below.

The shaft 21 includes a metallic core portion 21a. An upper portion of the metallic core portion 21a is integrally formed with the shaft 21, and the metallic core portion is in a toroidal shape downwardly extending from an upper portion thereof. The metallic core portion 21 includes a substantially conical surface whose diameter gradually decreases along with the axially downward direction from the upper portion thereof. In addition, a lubricant resin layer 23 is formed on the outer circumferential surface of the metallic core portion 21a.

Conical dynamic bearing portions 17 and 18 are formed in an axially spaced manner at the radial gap 26 between the inner circumferential surface of the sleeve 13 and the outer circumferential surface (bearing surface) of the lubricant resin layer 23 facing the inner circumferential surface of the sleeve 13. The inner circumferential surface of the sleeve 13 and the outer circumferential surface of the lubricant resin layer 23 composing the conical dynamic bearing portions 17 and 18 face each other with a several micrometer gap maintained therebetween. The radial gap 26 is continuously filled with a lubricant fluid such as esters oil and poly alpha olefinics oil.

A plurality of dynamic pressure generating grooves are formed at least either on the inner circumferential surface of the sleeve 13 or on the outer circumferential surface of the lubricant resin layer 23 of each of the conical dynamic bearing portions 17 and 18. The dynamic pressure generating grooves are circumferentially arranged so as to form a groove row 9 in a herringbone shape. When the shaft 21 rotates, a pumping action of the groove row 9 induces the dynamic pressure on the lubricant fluid such that the shaft 21 is supported without contacting the sleeve 13 by the dynamic pressure.

A circulation path 13c is formed on the sleeve 13. The circulation path 13c sidlingly penetrates the sleeve 13 and is filled with oil. When the rotor assembly 20 rotates, a pressure difference between an upper area of the conical dynamic bearing portion 17 and a bottom area of the conical dynamic bearing portion 18 is cancelled via the circulation path 13c.

A thrust gap 24 is formed between an upper end surface of the sleeve 13 and a bottom surface of an outer extending portion 23a of the lubricant resin layer 23 formed on the rotor hub 17. The thrust gap 24 is continuously formed with the radial gap 26 mentioned above.

A toroidal base portion 23b is formed at an outer end portion of the outer extending portion 23a of the lubricant resin layer 23. The toroidal base portion 23b downwardly extends from the outer extending portion 23a. An inner circumferential surface of the toroidal base portion 23b radially faces an outer circumferential surface of the flange portion 13d of the sleeve 13 with a radial gap 27 maintained therebetween.

A taper seal portion 28, to which the capillary force and the rotation centrifugal force is applied, is formed at a bottom side of the radial gap 27. The outer circumferential surface of the sleeve 13 radially faces an inner circumferential surface of a toroidal member 25 with a taper seal portion 28 maintained therebetween. The toroidal member 25 is fixed to a fixing portion 22d which is in a cylinder shape downwardly extending from the bottom surface of the rotor hub 22.

A gap between the bottom surface of the shaft 21 and the base portion of the sleeve 13, the radial gap 26, the thrust gap 24, the radial gap 27, and taper seal portion 28 are formed as a continuous gap which is continuously filled with lubricant oil such as oil.

A surface tension of the oil within the continuous gap and an outside air pressure are balanced only at the taper seal portion 28, and the interface of the oil and the air becomes a meniscus shape.

The flange portion 13d of the sleeve 13 axially faces the toroidal member 25 with a gap maintained therebetween. The flange portion 13d and the toroidal member 25 are arranged so as to be able to abut each other in order to prevent the rotor hub 22 from being axially removed from sleeve 13.

A method of molding the lubricant resin layer 23 is described below. Preferred materials for the lubricant resin layer 23 are the materials with a low shrinkage factor when they are molded, and the preferred example of the materials are lubricant resin materials such as carbon phenol, PPS, LCP, epoxy, and polyimide.

The lubricant resin layer 23 may be formed by insert molding with use of the metallic core 21a. In the insert molding, the metallic core portion 21a is arranged in an appropriate position within a die provided beforehand, and then, the lubricant resin material mentioned above is injected into the die.

The lubricant resin material is injected through an injection molding path 21b which axially penetrate the metallic core portion 21a and is coaxial with a rotation axis X.

More particularly, the lubricant resin material is inlet into a molding inlet 21b1 of the injection molding path 21b, formed on the upper side of the metallic core portion 21a. Then, through a molding outlet 21b2 of injection molding path 21b, formed on the bottom side of the metallic core portion 21a, the lubricant resin material is injected to the outer surface side of the metallic core portion 21a. The injection molding path 21b may be formed by using a screw hole for the disk fixation formed on the shaft 21 beforehand to facilitate the manufacturing process.

The lubricant resin material is injected from a portion on the rotation axis X and within the injection molding path 21b into the outer side of the metallic core portion 21a through the injection molding path 21b. The lubricant resin material injected to the outer side of the metallic core portion 21a flows from the molding outlet 21b2, formed on the bottom portion of the metallic core portion 21a, into the radially outward direction, so that the lubricant resin material covers the outer surface of the metallic core portion 21a with uniformed thickness. As a result, lubricant resin layer 23 with the uniformed thickness is provided.

More particularly, the lubricant resin material flows from the portion, which is within the injection molding path 21b and is on the rotation axis X of the metallic core portion 21a, into the outer surface of the metallic core portion 21a through the molding outlet 21b2, so that the lubricant resin material covers the outer surface of the metallic core portion 21a. Once reaching the top end portion of the outer surface of the metallic core portion 21a, the lubricant resin material flows into radially outward direction so as to cover the bottom circumferential surface 22b1 serving as a substratum surface of the disk portion 22b. Then, the lubricant resin material covers the inner circumferential surface of the fixing portion 22d. As a result, the lubricant resin layer 23 which covers a part of injection molding path 21b, the outlet 21b2, the outer surface of the metallic core portion 21a, the bottom surface of the rotor hub 22, and the inner circumferential surface of the fixing portion 22d respectively is formed.

The groove row 9 in a herringbone shape mentioned above and composing the radial gap 26 is formed on the outer surface of the lubricant resin layer 23. The groove row 9 is formed concurrently with the insert molding of the lubricant resin layer 23. With the outer circumferential surface of the metallic core portion 21a in the substantially conical shape, the dicing is smoothly performed. The groove row 9 may be molded concurrently with the insert molding of the lubricant resin layer 23 with a die having groove patterns thereon to facilitate the manufacturing process.

Moreover, the lubricant resin material is injected so as to radially outwardly flow from the outlet 21b2 during the insert molding process of the lubricant resin layer 23. As a result, the shrinkage factor of the resin is made uniform because the molding direction of the resin is made uniform; therefore, the thickness of the lubricant resin layer 23 is further uniformed.

The thickness of the lubricant resin layer 23 may be further uniform by adding fillers, which uniform the shrinkage factor, into the lubricant resin material. Therefore, an excellent dynamic pressure characteristic may be obtained.

As discussed above, the high mechanical strength and the precise processing accuracy may be obtained by using the metallic core portion 21a as a base frame of the shaft 21 according to the preferred embodiment of the present invention. In addition, the lubricant resin material is radially outwardly flowed from the outlet 21b2 to mold the lubricant resin layer 23 according to the preferred embodiment of the present invention. As a result, the lubricant resin material flows evenly, and the thickness of the lubricant resin layer 23 is further uniformed.

In this preferred embodiment, the precise processing accuracy may be achieved by the insert molding of the lubricant resin layer 23 using the metallic core portion 21a as an insert.

In this preferred embodiment, the lubricant resin layer 23 is formed in a sloping shape along with the outer surface of the metallic core portion 21a which is in a sloping share, such that the excellent lubricity is stably provided for a prolonged period.

In this preferred embodiment, the injection molding path 21b may be formed so as to axially penetrate the metallic core portion 21a by using the screw holes provided on the shaft 21. As a result, the injection molding path 21b may be easily formed.

In this preferred embodiment, the lubricant resin material is inlet into the molding inlet 21b1 arranged at the upper portion of the injection molding path 21b and is released from the outlet 21b2 arranged at the bottom portion of the injection molding path 21b. As a result, the arrangement space in which the injection molding device is placed and the molding space in which the lubricant resin layer 21 is formed are axially separated by the metallic core portion. Therefore, the lubricant resin layer may be manufactured in an efficient manner.

### Second Preferred Embodiment

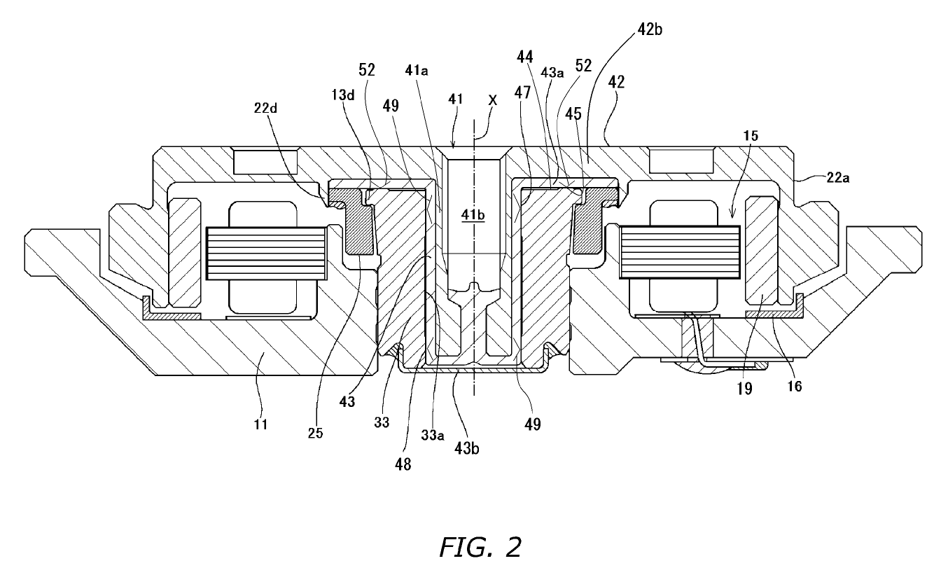

With referring to FIG. 2, the second preferred embodiment according to the present invention is described below. A motor according to the second preferred embodiment is a spindle motor used for a hard disk drive (HDD).

A sleeve 13 formed in a hollowed cylindrical shape is fixed to a substantially center portion of the base frame 11 by any suitable means such as press fitting and shrink fitting A central hole 33 is formed within the sleeve 13 and sidlingly penetrates the sleeve 13. Into the central hole 33, the shaft 41 composing a part of the rotor assembly is inserted.

A rotor hub 42 which composes the rotor assembly including the shaft 21 is formed in a substantially cupped shape. At an outer circumferential portion of the rotor hub 42, various kinds of recording disks such as magnetic disks may be placed. A basic structure of the rotor assembly is substantially similar to the structure mentioned in the first preferred embodiment, and the detail explanation is omitted.

A bottom opening portion of the sleeve 33 is occluded with a cover 43b so that the oil retained in radial dynamic bearing portions 47 and 48 does not leak. An upper end surface of the sleeve 33 axially adjacently faces a bottom end surface of a disk portion 42b of the rotor hub 42.

The radial dynamic bearing portions 47 and 48 are formed in an axially spaced manner at a radial gap 46 between the inner circumferential surface of the sleeve 33 and outer circumferential surface of the lubricant resin layer 43 facing the inner circumferential surface of the sleeve 33. The inner circumferential surface of the sleeve 33 and the outer circumferential surface of the lubricant resin layer 43 composing the radial dynamic bearing portions 47 and 48 face each other with a several micrometer gap maintained therebetween. The radial gap 46 is continuously filled with a lubricant fluid such as esters oil and poly alpha olefinics oil.

A plurality of dynamic pressure generating grooves are formed at least either on the inner circumferential surface of the sleeve 33 or on the outer circumferential surface of the lubricant resin layer 43 of each of the conical dynamic bearing portions 47 and 48. The dynamic pressure generating grooves are circumferentially arranged so as to form a groove row 49 in a herringbone shape.

When the shaft 41 rotates, a pumping action of the groove row 49 induces the dynamic pressure on the lubricant fluid such that the shaft 41 is supported without contacting the sleeve 33 by the dynamic pressure.

A bottom thrust dynamic bearing portion 45 is provided at a thrust gap 44 between the upper end surface 33 of the sleeve 33 and the bottom end surface (bearing surface) of an outer circumferential extending portion 43a of the lubricant resin layer 43. A groove row 52 formed in a herringbone shape are formed as a dynamic pressure generating groove at least either on the upper end surface of the sleeve 33 or on the outer circumferential extending portion 43a which compose thrust dynamic bearing portions 45.

The thrust gap 44 is continuous to the radial gap 46, such that the gap 46 and the thrust gap 44 are continuously filled with the lubricant fluid. When the rotor assembly rotates, a pumping action of the groove row 52 induces the dynamic pressure on the lubricant fluid such that the shaft 41 and the rotor hub 22 are supported without contacting each other by the dynamic pressure.

The shaft 41 includes a metallic core portion 41a. The metallic core portion 41a is integrally formed with the upper portion of the rotor hub 42. The metallic core portion is in a substantially cylindrical shape downwardly extending from the upper portion thereof. On the outer surface of the metallic core portion 41a, a lubricant resin layer 43 having uniformed thickness is integrally formed by molding.

Because the composition and the manufacturing method of the lubricant resin layer 43 are similar to the lubricant resin layer 23 described in the first embodiment mentioned above, the detailed explanation is omitted. The lubricant resin layer 43 is formed so as to cover the outside surface of the metallic core portion 41a from the bottom side of metallic core portion 41a. Also, the lubricant resin layer 43 is formed so as to cover the bottom surface of the rotor hub which is continuous with the upper outside surface. In addition, the lubricant resin layer 43 composes the outer circumferential extending portion 43a.

With the compositions according to the second preferred embodiment of the present invention, the similar effect described in the first preferred embodiment may be obtained as well.

Recording Disk Driving Device

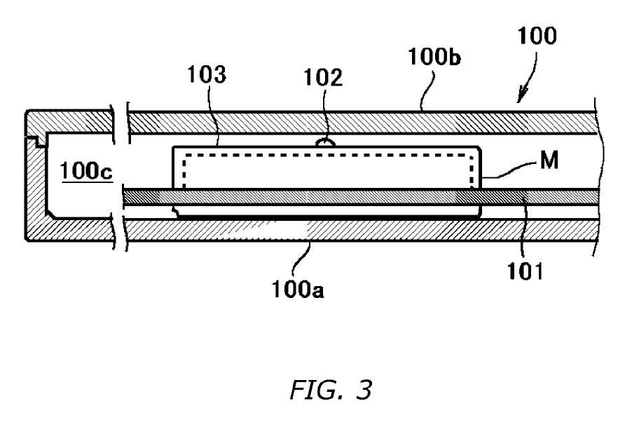

A spindle motor of the preferred embodiments according to the present invention may be installed into the recording disk driving devices such as a hard disk drive (HDD) shown in FIG. 3.

As shown in FIG. 3, a spindle motor including a fluid dynamic bearing according to the present invention is fixed to a housing plate 100a composing a sealed housing 100. With the housing plate 100a and a housing plate 100b fitted together, an internal space 110C of the housing 100 having a spindle motor M is kept clean.

A recording disk 101 such as a hard disk are placed on the rotor hub of the spindle motor M, then the recording disk 101 is supported with a clamp member 103 which is fixed to the rotor hub by a screw 102.

The present invention is not limited to the illustrated preferred embodiment, thereby it is possible to make various modifications without departing from the scope of the present invention.

In the preferred embodiments mentioned above, the injection molding path is provided within the shaft to inject the lubricant resin material. Alternatively, the lubricant resin material may be directly injected to the outer surface of the shaft.

In the preferred embodiments mentioned above, the spindle motor according to the present invention is used for the HDDs. However, the present invention may be applied to the various kinds of fluid dynamic bearing other than the spindle motors for the HDD.

The fluid dynamic bearing according to the present invention may be used for various kinds of rotation driving devices typified by the HDD mentioned above.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A method of manufacturing a fluid dynamic bearing which includes a sleeve having an inner circumferential surface, a shaft being rotatable relatively to the sleeve and having an outer circumferential surface facing the inner circumferential surface when being inserted into the sleeve, a lubricant fluid retained between the inner circumferential surface of the sleeve and an outer circumferential surface of the shaft, the method comprising the steps of:
providing a metallic core portion which has a injection molding path and is a part of the shaft, the injection molding path penetrating the metallic core portion along with a rotation axis;
providing a die;
arranging the metallic core portion into the die; and
forming resin layer on an outer surface of the metallic core portion by injecting molten resin through the injection molding path.

2. A method of manufacturing a fluid dynamic bearing as set forth in claim 1, wherein the molten resin is injected from a position locating on the rotation axis and within the injection molding path.

3. A method of manufacturing a fluid dynamic bearing as set forth in claim 1, wherein:
the sleeve is formed in a cylindrical shape whose axially bottom end is occluded;
the injection molding path includes an inlet at an axially upper side thereof and an outlet at an axially bottom side thereof; and
the molten resin flows on the outer surface of the metallic core portion through the outlet.

4. A method of manufacturing a fluid dynamic bearing as set forth in claim 3, wherein a diameter of the outer surface of the metallic core portion gradually decreases along with an axially downward direction.

5. A method of manufacturing a fluid dynamic bearing as set forth in claim 1, wherein groove patterns are formed on the portion of the inner face of the die, and the fluid dynamic generating grooves are formed at the step of forming a resin layer.

6. A method of manufacturing a fluid dynamic bearing as set forth in claim 1, wherein the molten resin includes any of carbon phenol, polyphenylene sulfide (PPS), and liquid crystalline polyester (LCP), epoxy and polyimide

7. A method of manufacturing a fluid dynamic bearing as set forth in claim 1, wherein the molten resin includes a filler which uniforms a shrinkage factor.

8. A spindle motor comprising:
a fluid dynamic bearing manufactured by the method as set forth in claim 1;
a rotor supporting a rotor magnet and rotating around the rotation axis relatively to the sleeve or the shaft; and
a stator facing the rotor magnet.

9. A recording disk driving device on which a recording disk is loaded comprising:
a housing;
the spindle motor as set forth in claim 8 fixed within the housing and rotating the recording disk; and
a head reading or writing information from or on the recording disk.

10. A method of manufacturing a fluid dynamic bearing including a pair of dynamic bearing portions, each bearing face of which inclines from the rotation axis in difference degrees and is connected each other, the method comprising the steps of:
providing a metallic core portion including one bearing surfaces of one dynamic bearing portion and the other bearing surface of the other dynamic bearing portion;
providing a metallic core portion including one substratum circumferential surface which inclines from the rotation axis in first degrees, and second substratum circumferential surface which inclines from the rotation axis in second degrees being different from first degrees;
providing a die;
arranging the metallic core portion into the die; and
forming resin layer on an outer surface of the metallic core portion by injecting molten resin through the injection molding path.

11. A method of manufacturing a fluid dynamic bearing as set forth in claim 10, wherein one dynamic bearing portion is provided at a portion between a resign layer which is formed on the one bearing surface and an inner circumferential surface of the sleeve in a substantially cylinder shape which faces the resin layer.

12. A method of manufacturing a fluid dynamic bearing as set forth in claim 11, wherein:
outer diameter of the one bearing surface gradually decreases along with an axially downward direction; and
inner diameter of inner circumferential surface of the sleeve gradually decreases along with an axially downward direction.

13. A method of manufacturing a fluid dynamic bearing as set forth in claim 11, wherein the other dynamic bearing portion is provided at a portion between the resign layer which is formed on the other bearing surface and an inner circumferential surface of the sleeve in a substantially cylinder shape which axially faces the resin layer.

14. A method of manufacturing a fluid dynamic bearing as set forth in claim 10, wherein the other dynamic bearing portion is provided at a portion between the resign layer which is formed on the other bearing surface and an inner circumferential surface of the sleeve in a substantially cylinder shape which axially faces the resin layer.

15. A method of manufacturing a fluid dynamic bearing as set forth in claim 10, wherein:
the metallic core portion includes a injection molding path penetrating the metallic core along with the rotation axis; and
the molten resin is injected from the injection molding path to form the resin layer on one and the other bearing portions.

16. A method of manufacturing a fluid dynamic bearing as set forth in claim 15, wherein the molten resin is injected from a position locating on the rotation axis and within the injection molding path.

17. A method of manufacturing a fluid dynamic bearing as set forth in claim 15, wherein:
the sleeve is formed in a cylindrical shape whose axially bottom end is occluded;
the injection molding path includes an inlet at an axially upper side thereof and an outlet at an axially bottom side thereof; and
the molten resin flows to the bearing surfaces of the metallic core portion through the outlet.

18. A method of manufacturing a fluid dynamic bearing as set forth in claim 10, wherein the step of forming resin layer further comprises:
forming a dynamic pressure generating groove on at least one of the bearing surfaces of the dynamic bearing portions.

19. A method of manufacturing a fluid dynamic bearing as set forth in claim 10, wherein the step of forming resin layer further comprises:
forming a dynamic pressure generating groove on the one and the other bearing surfaces of the dynamic bearing portions.

20. A method of manufacturing a fluid dynamic bearing as set forth in claim 10, wherein the molten resin includes any of carbon phenol, polyphenylene sulfide (PPS), and liquid crystalline polyester (LCP), epoxy and polyimide.

21. A method of manufacturing a fluid dynamic bearing as set forth in claim 10, wherein the molten resin includes a filler which uniforms a shrinkage factor.

22. A spindle motor comprising:
a fluid dynamic bearing manufactured by the method as set forth in claim 10;
a rotor supporting a rotor magnet and rotating around the rotation axis relatively to the sleeve or the shaft; and
a stator facing the rotor magnet.

23. A method of manufacturing a fluid dynamic bearing which includes: a sleeve having an inner circumferential surface; a shaft being rotatable relatively to the sleeve and having an outer circumferential surface facing the inner circumferential surface when being inserted into the sleeve; a disk portion connected to the outer circumferential surface and radially outwardly extending from the outer circumferential surface, the disk portion having a bottom surface facing an upper surface of the sleeve; and a lubricant fluid retained between an upper surface and a bottom surface of the shaft, the method comprising the steps of:
providing a metallic core portion which is a part of a shaft and a bottom circumferential surface which is included to the disk portion as a substratum surface;
providing a die,
arranging the metallic core portion and the bottom circumferential surface; and
forming resin layer on an outer surface of the metallic core portion and on the bottom circumferential surface by injecting molten resin into the die.

24. A method of manufacturing a fluid dynamic bearing as set forth in claim 23, wherein:
the metallic core portion includes a injection molding path penetrating the metallic core along with the rotation axis; and,
the molten resin is injected from a injection molding path to form the resin layer on the outer surface of a metallic core portion and on a bottom circumferential surface.

25. A method of manufacturing a fluid dynamic bearing as set forth in claim 24, wherein the molten resin is injected from a position locating on the rotation axis and within the injection molding path.

26. A method of manufacturing a fluid dynamic bearing as set forth in claim 24, wherein:
the sleeve is formed in a cylindrical shape whose axially bottom end is occluded;
the injection molding path includes an inlet at an axially upper side thereof and an outlet at an axially bottom side thereof; and
the molten resin flows on the outer surface of the metallic core portion and on the bottom circumferential surface through the outlet.

27. A method of manufacturing a fluid dynamic bearing as set forth in claim 23, wherein the step of forming resin layer further comprises:
forming a dynamic pressure generating groove on the outer surface of the metallic core portion and on the bottom surface of the disk portion.

28. A method of manufacturing a fluid dynamic bearing as set forth in claim 23, wherein the metallic core portion and the disk portion are integrally formed into a single piece member without including any seam.
